(19) United States
(12) Patent Application Publication
(10) Pub. No.: US 2007/0075134 A1
(43) Pub. Date: Apr. 5, 2007

(54) METHOD AND APPARATUS FOR ATTENDANT ASSISTED GIFT CARD PRINTING

(75) Inventors: David Perlow, Cambridge, MA (US); Jeremy Gilbert, Lowell, MA (US); David Hout, North Andover, MA (US); Gary Snow-Brine, Wells, ME (US)

Correspondence Address: FINCH & NGUYEN PLLC, P.O. BOX 1358, CONCORD, NH, 03302, US

(73) Assignee: Cruz Bay Solutions, Inc.

(21) Appl. No.: 11/534,611

(22) Filed: Sep. 22, 2006

Related U.S. Application Data
(60) Provisional application No. 60/719,680, filed on Sep. 22, 2005.

(51) Int. Cl. G06K 5/00

(52) U.S. Cl. 235/380

(57) ABSTRACT

Methods and systems for printing gift cards are provided. Gift cards may be customized and may be printed remotely from the point of customization. Customized gift card designs can be reviewed by the issuer for content prior to printing the customized gift card.

### RELATED APPLICATION

This application claims priority from U.S. Provisional Patent Application Ser. No. 60/719,680 filed Sep. 22, 2005, titled METHOD AND APPARATUS FOR ATTENDANT ASSISTED GIFT CARD PRINTING and which is incorporated by reference in its entirety herein.

### BACKGROUND

1. Field of the Invention

The present invention relates to a self service device and, in particular, to a self-service device that allows customers to personalize, purchase and quickly receive activated gift cards while allowing monitoring of the gift card design.

2. Discussion of Related Art

In recent years, retailers have implemented various programs to encourage current and future customers to purchase an increasing amount of products and services from their stores. One such program involves the sale of pre-paid gift or debit cards. By offering gift cards to customers, retailers benefit by increased business from the card recipients as well as by a reduced number of returned opened or unopened gifts which can be potentially time-consuming and expensive for the retailer to restock and resell. These cards, in return, offer a customer a convenient gift idea for the hard to please significant other or friend.

Traditionally, these gift cards were offered in fixed monetary values and displayed at or near the cash register. Upon checking out, customers had the opportunity to purchase the gift card along with the other items they had selected for purchase. Gift cards may be divided into closed loop and open loop cards. Open loop gift cards include those issued by credit card companies that can be used at any retailer that accepts the credit card for payment. However, open loop cards may not be as beneficial to the retailer as closed loop cards because, unlike a closed loop card, an open loop card will likely be redeemed at a retailer different from the one where it was purchased.

This traditional approach, however, has several disadvantages. First, seasons in which gift cards are most popular are also seasons in which retailers see the longest checkout lines. Thus, a customer wishing to purchase a pre-paid gift card needs to stand in potentially long lines to do so. Additionally, if a customer wishes to buy gift cards for use at different retailers, the customer would need to visit each retailer and wait in a number of long lines to purchase each retailer's gift card. To reduce the time a customer spends in line and to conserve financial resources spent on hiring additional staff during busy hours, many businesses are now using self-service kiosks. Customers can now purchase pre-paid retailer specific debit cards at a kiosk for use at that particular retailer.

### SUMMARY OF INVENTION

In one aspect, the invention pertains to a method of designing and personalizing a gift card design, the method comprising selecting a gift card type at an input device at a retail location, selecting one or more graphic images for printing on the card, and printing the one or more selected graphic images on a printer at a second location that is remote from the input device.

In another aspect, a system for printing gift cards is provided, the system comprising a customer input device for customizing a gift card, the customer input device located at a retail location, a print server in communication with the input device, and a gift card printer in communication with the print server, the gift card printer being remote from the customer input device.

In another aspect, a system for customizing a gift card is provided, the system comprising a customer input device, a remote gift card reviewer in communication with the input device, and a gift card printer constructed and arranged to be controlled by the gift card reviewer.

In another aspect, a method of approving a gift card design is provided, the method comprising allowing a customer to customize a gift card design at a first location, transmitting an image of the gift card design to a gift card reviewer, and subsequently allowing or disallowing the printing of a gift card including the gift card design.

The subject matter of this application may involve, in some cases, interrelated products, alternative solutions to a particular problem, and/or a plurality of different uses of a single system or article.

### BRIEF DESCRIPTION OF DRAWINGS

In the drawings, FIG. 1 gives an overview of an embodiment of an attendant assisted gift card printing system.

FIG. 2 is a flow chart diagram showing the flow of information between the major system components of one embodiment of the invention.

FIG. 3 is a flow chart diagram showing the general flow of the application environment software as it will appear to the user of the gift card system in one embodiment of the invention.

FIG. 4 is a flow chart diagram showing the general flow of the application environment software as it will appear to the gift card reviewer and/or in-store personnel in one embodiment of the invention.

### DETAILED DESCRIPTION

The following description pertains to a method and apparatus that may allow customers to personalize, purchase and quickly receive gift cards while providing for prior intervention by store personnel, other authorized parties, or a computer, which will ensure that the cards adhere to store policy prior to printing and fulfillment of the purchase transaction. This self-service device runs a software application environment that allows a user to personalize each gift card by selecting graphics and creating text to print on the card as well as allowing the user to specify the information required to purchase and activate each card. This software application environment may provide interfaces between the major physical components of the self-service device and may communicate with a gift card review station. The gift card review station may in turn communicate with a local print server for purposes of queuing print requests. The print server can forward approved print requests to the card printer(s) and may communicate with a remote server for purposes of gift card activation and processing of the financial transaction. Gift card activation and processing of the financial transaction may also be done manually by store personnel at a POS terminal. By utilizing a gift card reviewing system along with the self-service device, a personalized gift card adhering to store policy may be printed on-site or off-site and may support any number of gift card designs for any number of different retailers.

Card printers may be local, on site, off site or remote. A printer and input device (e.g., a kiosk) are “remote from each other if they are not contained in the same cabinet. If the printer is “on site this means that the printer is in the same building as is the input device. If the printer is “off site this means that the printer is in a separate building from the input device.

While a traditional gift card may be a good and practical gift, it tends to lack the ability to reflect the personality of the giver or the recipient in the way that other more personal gifts can. This liability can be significantly mitigated by allowing a gift card to be customized with text messages, and graphics or pictures that may be user-generated or uploaded from a user device.

Customization options allow the user to add personalized graphics such as a photograph, clip art or handwriting to the gift card. For example, see U.S. patent application Ser. No. 11/432,828 titled METHOD AND APPARATUS FOR PRINTING A GIFT CARD, which is incorporated by reference in its entirety herein. Photographs may be uploaded from user devices such as digital cameras, camcorders, cell phones, and/or portable media players. The kiosk may also include a camera for taking digital images on site or an optical media drive for uploading media from a user disc. Any number of retailer logos and designs may be associated with a kiosk as cards need not be pre-printed prior to their sale at the kiosk. Furthermore, digital designs can be uploaded quickly from a central location to provide, for example, holiday or seasonal designs. Designs may also be customized for specific geographical areas. For instance, cards sold in specific regions may include graphics for local sports teams, points of interest, or celebrities. In some embodiments, designs may be drawn from onsite databases, offsite databases, from a user device such as a cell phone or from an input device such as a tablet/stylus. The different designs may be used independently or together on a single gift card.

Unfortunately, when customers can create their own designs, the graphics and text that are used by the customer may not always be appropriate for a gift card. Therefore, a retailer or other gift card issuer may like to have control over the content that is finally printed on the card. Thus, there is a need for a method and apparatus that can dispense customizable gift cards that may be reviewed for inappropriate content prior to printing.

On a customizable gift card, retailers and/or card issuers may also include additional printable information or identifying features. Such information may include, for example, URL's, phone numbers, advertising directed to the purchaser's demographic, “Terms and Conditions, memberships, and a card number. Designs may be stored in a user's “account so that they can be edited and re-used by the user in the future.

As illustrated in FIG. 1 a customer may approach a gift card design kiosk 19 to buy one or more customized gift cards. The customer may produce a customized gift card design that, prior to being printed to the card, is submitted for approval to a gift card reviewer located in or outside of the store. For example, the card may be electronically submitted for review to a card reviewer. The card reviewer may be a person who observes an image of the card design on a display monitor. The gift card design kiosk may be in communication with a computer, for example a PC, that can provide the image to the display monitor.

In one preferred embodiment, gift card design kiosk 19 includes a CPU, an area of main memory for executing the program code of the application environment 14 under the direction of the CPU, a storage device, and at least two input and/or output devices. The CPU may be a PC and may use, for example, Microsoft Windows XP operating system and Cruz Bay Solutions' iGift™ Application. In order for the customer to communicate with the kiosk 19, kiosk 19 may have at least one, if not a combination of the following input devices: a touch screen display, a keyboard and mouse, a microphone or a tablet and stylus along with an appropriate interface which allows the respective input device to communicate with the CPU. The major physical components of the kiosk 19 may be housed within one single cabinet or within multiple cabinets.

Optional input ports and devices may include a universal serial bus (USB) port for downloading media from a flash or similar drive, a FIREWRE port, a DVD or CD or optional combination drive, a scanner for scanning images, a microphone, a camera, a short range wireless device 13 such as a BLUETOOTH interface device or similar device and an infrared port for uploading media via infrared transmission. The kiosk 19 may also contain input devices including identification devices such as a magnetic stripe reader/writer 10, a UPC scanner, an RFID reader or a “smart chip reader. Each input device may also have the appropriate interface to enable the input device to communicate directly or indirectly with the CPU. The kiosk 19 may also include a secure PIN entry device. The PIN entry device may allow entry of a personal identification number that may be required to activate a payment source such as a debit card.

User identification and authentication can also be verified by using a biometric identifier such as, for example, a fingerprint or iris scanner. Voice authentication may also be used. In some embodiments, one or more input devices may also serve as output devices. For example, a user may be able to save a card design to a digital media card or other device.

Output devices linked to the CPU of kiosk 19 may include a monitor and/or a card printer 17 and/or a receipt printer 11. The monitor may be used to query the user and may provide an image of the gift card prior to printing. Gift card printers include, for example, inkjet, laser and dye sublimation printers. One printer may serve multiple kiosks. Although typically networked together, printers and input devices (e.g. kiosk) may be remote and may be located in different portions of the retail establishment. In some embodiments, remote printers may be located, for example, greater than 50 feet, greater than 100 feet, greater than 200 feet, or greater than 500 feet away from the input device. Printers may be chosen, in part, based upon the material that the gift card is composed of. Gift cards to be printed may be made of synthetic or natural materials. Synthetic materials include, for example, PVC, PET, PET-G, ABS and/or polycarbonate. Natural materials include, for example, paper and/or materials made from corn such as CornCard USA cards (Arthur Blank & Co., Boston, Mass.) made from NatureWorks PLA plastic substitute.

A preferred embodiment uses dye sublimation re-transfer technology, as in Dai Nippon Printing's DNP CX series printers. It has been found that with many cards, dye sublimation re-transfer printing is a preferred technology. A printer using this technology first may print a reverse image to a laminate transfer film which is then bonded to the face of a substrate. As the image is first printed to a laminate transfer film which can be cut down to fit the exact surface of the substrate, the risk of damage to the print head that occurs when trying to print directly to the edges of a substrate is eliminated. This technique has been shown to provide superior graphics on gift cards when compared to other tested printing methods. A dye sublimation re-transfer printer may be capable of printing to either or both sides of a gift card.

By printing a gift card at the time of sale, the system can support any number of gift card designs for any number of different retailers. This may also allow retailers and other gift card vendors to instantly update designs. For example, seasonal designs may be implemented at appropriate times or weddings, birthdays, and sports championships may be memorialized on a gift card. Other output devices may include receipt printer 11 such as the Star TUP 992, a video display, and speakers.

Network appliance 13 may also be included with kiosk 19 and may communicate either wirelessly or via wires with a network such as a LAN or the internet. Network appliances include the Multitech MTCBA-G-UF2, a wireless GPRS modem that can be used for remote management, accessing the world-wide web and for communicating with a gift card review station 15 and a print server 16. Print server 16 may be connected to one or more card printers 17 which may print on one or both sides of the card. Print server 16 may also provide access to all network components required for “activating the gift card from the standpoint of the gift card processor. Other wireless protocols include, for example, CDMA, SMS and iDen. Communication may be incoming, outgoing, or both.

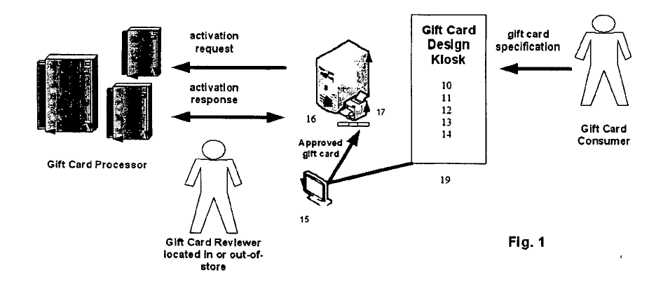

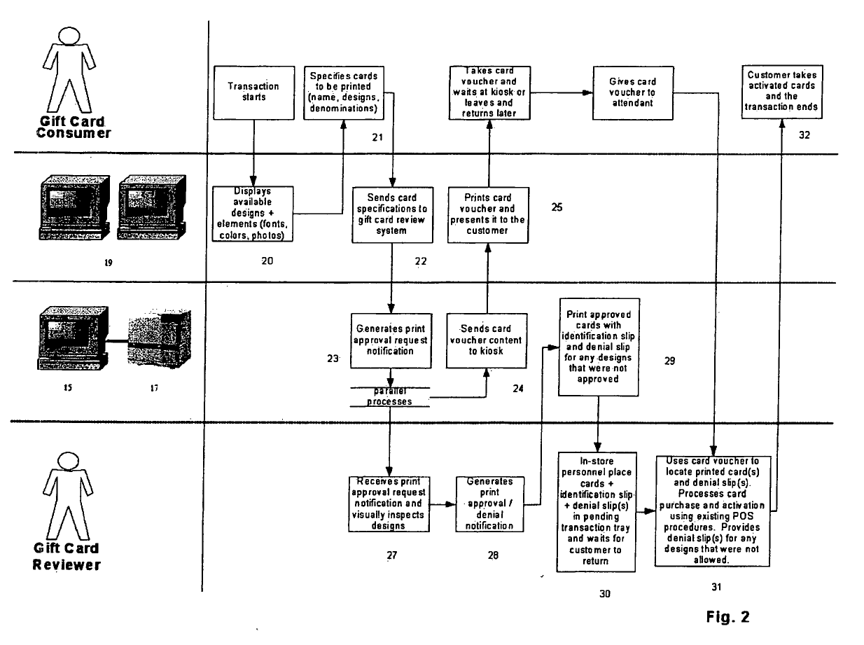

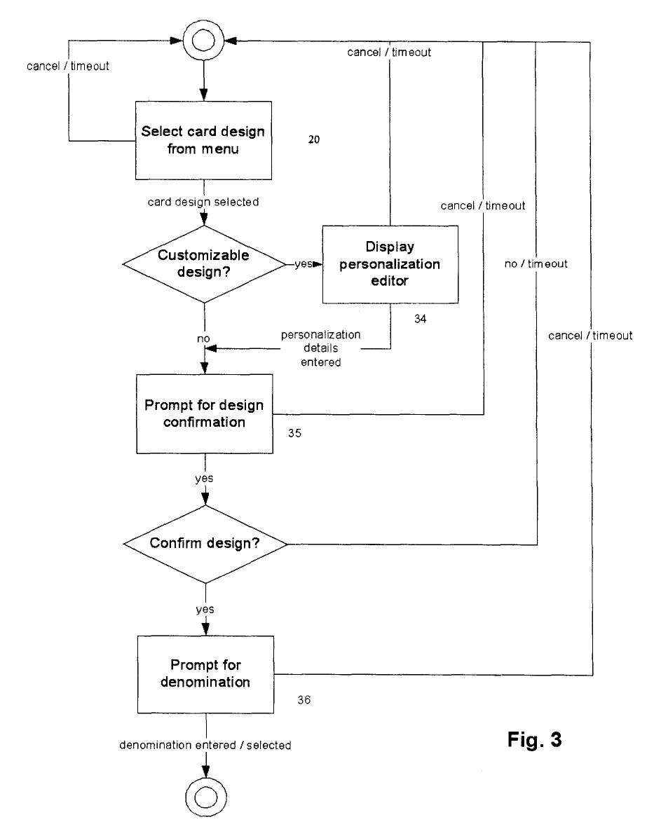

As described in FIG. 2 and FIG. 3 a customer may approach a kiosk 19 to customize a gift card. A user interface can provide the customer with various screens and prompts which can help guide the customer through the process. After the customer has approached and engaged the kiosk 19, the customer may be presented with a card selection menu 20 through the user interface from which he or she may pick a gift card template from a list of available gift card templates. These templates may be stored in a database locally or remotely as digital graphic files. If the digital graphic files are stored in a database remotely and are distributed over a network, this database may serve multiple kiosks. Also, a single kiosk may support the production of gift cards from multiple retailers.

Once the customer has selected a gift card template, the user interface may prompt the customer to customize or personalize the gift card. If personalization of the gift card is desired, a personalization editor 34 can be displayed. The personalization editor may be a “what you see is what you get type, where a customer can preview the appearance of graphics and text as it will appear on the final printed gift card. The customer will have the option of creating or downloading digital graphics from a personal device connectable through a universal serial bus (USB) port or other interface. Personal devices may include, for example a camera, a flash drive, a mobile telephone, a portable media player, optical media such as a CD or DVD or any other device capable of retaining digital information or images. A transfer may be facilitated by an appropriate interface such as USB, infrared, FIREWIRE, BLUETOOTH, or an optical reader. The customer may also pull digital graphics from a local or remote design database. For example, the customer may access an internet photo service or other source of graphics over the internet or another computer network. Text may also be created and edited by means of a physical keyboard or a virtual keyboard displayed on a touch screen. Text may also be created via a microphone coupled with speech recognition software. Once graphics and text are created and/or selected, the user interface may prompt the customer for confirmation of the final design 35.

In a preferred embodiment, once confirmation of the final design has been made by the customer, the kiosk 19 sends the card specifications to a gift card review station 15 for review by a remote gift card reviewer as shown in step 22. The gift card review station may be remote on site or may be off site. The remote gift card review station may be in a store or outside of the store, in the same or different city or state, and even in a different country from printer 17 and/or kiosk 19. The review station may be networked to the input device but may be, for example, greater than 50 feet, greater than 100 feet, greater than 200 feet or greater than 500 feet from the input device. The gift card review station and the gift card reviewer may be one unit or may be separate units such as a display and a human reviewer in position to observe the display. The gift card reviewer, if a computer, may also reside within the self-service device itself. The gift card reviewer may be a human, a computer or a combination of both.

Once the gift card review station 15 receives the print approval request, notification is sent to the gift card reviewer in step 23. Additionally, customer voucher content may be sent to the kiosk 19 in step 24 after which the kiosk 19 prints the voucher and presents it to the customer in step 25. This voucher may contain the time and location where the customer's approved, printed gift card may be picked up. It may also contain information to assist the in-store personnel in locating the printed gift card among the contents of the pending transaction tray.

Upon notification of the print approval request, the gift card reviewer inspects the gift card design(s) in step 27 to ensure that the content of the design(s) comply with store policy. If the card design content complies with store policy, the gift card reviewer generates a print approval notification as shown in step 28. Conversely, if the card design content does not comply with store policy, a denial notification is generated. Card designs may be denied, for example, if the reviewer perceives objectionable graphics or text, copyright violations, or trademark disparagement. If one or more cards are denied, the gift card reviewer can instruct the transaction server to not charge the customer for the denied card or cards. If the print request is denied, the gift card reviewer may print a denial slip which sets forth the reason(s) for the denial and can indicate that the customer has not been charged for the value of the card.

In step 29 the gift card reviewer may print any approved cards along with an identification slip. The reviewer may also instruct a transaction server to apply value to the approved cards. Alternatively, the approved card may be printed at the design kiosk or an alternative location on or off site. The printed gift card and identification slip and/or a denial slip may be placed in the pending transaction tray in step 30 while in-store personnel await the return of the gift card customer.

At the appointed time printed on the gift card voucher, the customer can proceed to the location printed on the voucher and may hand the voucher to the in-store personnel. The in-store personnel may then use the voucher to locate the printed card or denial slip as shown in step 31. During this step the in-store personnel may also process the gift card purchase and gift card activation using existing point-of-sale procedures. Card purchases and activation may also be initiated as self-service transactions at kiosk 19. In step 32 the customer takes the activated card and the transaction ends. Alternatively, a message can be sent from the gift card reviewer's location to the kiosk allowing or denying printing and issuance of the card at the kiosk or at another printing location at the same site as the kiosk.

By way of example, a customer may design five different cards and, prior to printing the card, may have one of them rejected by the reviewer. The four approved cards will be printed, have value assigned to them, and the funding accounts will be debited. A voucher will identify the rejected card and indicate that the designated funding account has not been debited. A reason for the rejection may also be provided.

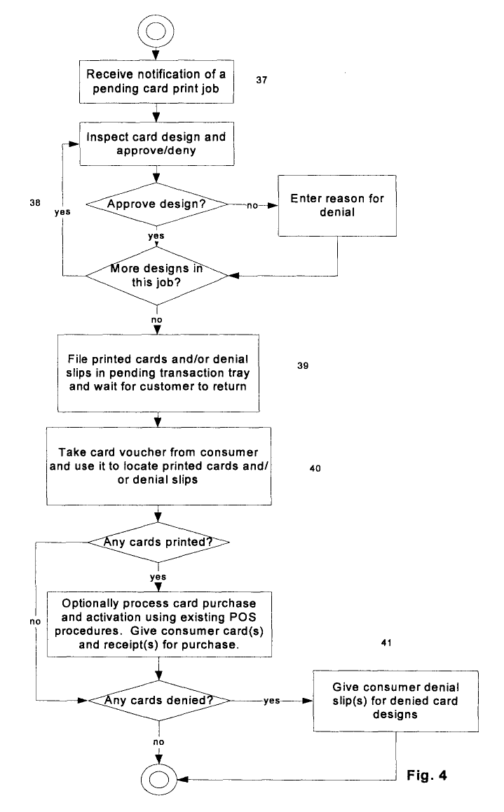

As illustrated in FIG. 4, a gift card reviewer may attend to a gift card review station 15. The gift card reviewer may be a human, a machine or a combination of both. Typically, a human will examine the design image on a monitor, but the process may also be computerized. For instance, gift card review station 15 may be a PC and may also be programmed to perform an automated reviewing function. Upon receiving a notification 37 of a pending card print job, the gift card reviewer may inspect the card design in step 38 to ensure that it complies with store policy. If the design is approved by the gift card reviewer, the gift card review station 15 may prompt the gift card reviewer to review any additional cards. If for any reason the card design does not comply with store policy and the print request is denied, the gift card reviewer can input the specific reason for denial into the gift card review station 15.

Once the cards or denial slips are printed in step 39, the in-store personnel can file the printed card(s) or denial slip in the pending transaction tray and waits for the customer to return. In step 40, upon return of the customer, the in-store personnel may receive the gift card voucher from the customer and may use it to locate the gift card among the contents in the pending transaction tray. After the in-store personnel locates the card he or she may also process the card purchase and card activation using existing point-of-sale procedures or using a transaction server. Once the gift card purchases and activation are complete, the in-store personnel may give the customer the gift card and a receipt. If any cards were denied, the in-store personnel in step 41 may give the customer the denial slip(s) for denied card designs.

In another embodiment, a card number generator may obtain an unused number from a card number database which can be local to kiosk 19 or distributed over a network. Once the card number generator obtains an unused number from this database it may communicate this number to kiosk 19 which may associate the number with a specific card. The number may be associated with the card in one or multiple ways such as by printing text, printing a bar code, writing to a magnetic strip, or encoding an RFID smartcard or similar. If the number is to be printed, it may be printed, for example, as text, a barcode, or both, at a pre-determined location on the card. Magnetic stripe reader/writer 10 can be used to write the number to the magnetic stripe on the card. An RFID writer may be used to store the number on a contactless RFID card.

Redundant versions of writing the number to the card may be used. The kiosk may also provide a mechanism for the customer to provide payment for the gift card. For example, the kiosk 19 may prompt the user for the desired value to associate with the gift card. The user may be prompted by a user interface to deposit sufficient cash into the note accepter or to swipe or deposit a debit or credit card in the debit/credit card reader so that the account associated with the debit or credit card may be charged an appropriate amount. Print server 16, which may be offsite, can communicate with a transaction server or a retailer POS system in order to coordinate the stored value and financial transactions. When sufficient cash has been deposited in the note accepter or when other previously issued gift cards (with value) are inserted, or when a payment processor verifies that sufficient funds are available in the associated credit/debit account, and upon card design approval by the gift card reviewer, the print server 16 may communicate with a stored value processor to request approval of card activation for the desired value. Once the transaction is approved, Kiosk 19 or print server 16 may provide card printer 17 the print parameters and instructions to print the gift card. Kiosk 19 may also give write parameters to the magnetic stripe reader/writer along with instructions to write the ID or the value of the card to the magnetic stripe. Once printing to the card and writing to the magnetic stripe is completed the customized gift card can be dispensed to the user at kiosk 19, or the gift card may be filed in the pending transaction tray with in-store personnel for later pick-up by the customer. A receipt may also be printed from receipt printer 11 for the records of the user.

In another aspect a customer may customize a gift card from a remote location such as from home or the office. The application environment software may be temporarily downloaded to a user device in the remote location to aid the customer in customizing a gift card. Alternatively, the application environment may be accessed through a retailer's website on the World Wide Web. Once a customer has customized a gift card design, the card design may be sent to a gift card review station 15 to ensure that the gift card design complies with store policy. If the card design is approved by a gift card reviewer, a voucher may be downloaded by the customer for printing. If the card design is denied by the gift card reviewer, the customer may be sent notification of the denial which sets forth the reason for the denial. The downloadable voucher may contain such information as the address and driving directions of the retailer where the card is printed and any additional instructions for picking up the gift card from the retailer. The voucher may also contain a customer identification number and/or a bar code. Once the customer has arrived at the retailer, the customer may present in-store personnel with the voucher for gift card retrieval. Alternatively, a customer may approach a self-service device where the customer may scan the bar code printed on the voucher, may enter the customer ID number printed on the voucher or may enter other personal information that would help the kiosk in retrieving the customer's personalized card design for printing. A customer may enter payment information at home prior, on the self-service device or may provide payment to the in-store personnel when the customer picks up the printed card. Alternatively, the customer may enter payment information at home and request that the card be delivered via mail to himself or herself or a third party.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention.

The indefinite articles “a and “an, as used herein in the specification and in the claims, unless clearly indicated to the contrary, should be understood to mean “at least one. The phrase “and/or, as used herein in the specification and in the claims, should be understood to mean “either or both of the elements so conjoined.

All references, patents and patent applications and publications that are cited or referred to in this application are incorporated in their entirety herein by reference.

What is claimed is:

1. A method of designing and personalizing a gift card design comprising:
selecting a gift card type at an input device at a retail location;
selecting one or more graphic images for printing on the card; and
printing the one or more selected graphic images on a printer at a second location that is remote from the input device.

2. The method of claim 1 further comprising reviewing the card design by a party other than the customer.

3. The method of claim 1 wherein the image is printed on laminate transfer film.

4. The method of claim 1 wherein the input device comprises a kiosk and a gift card is printed at a printer remote from the kiosk.

5. The method of claim 1 wherein the card is printed using a re-transfer dye sublimation process.

6. A system for printing gift cards comprising:
a customer input device for customizing a gift card, the customer input device located at a retail location;
a print server in communication with the input device; and
a gift card printer in communication with the print server, the gift card printer being remote from the customer input device.

7. The system of claim 6 further comprising a gift card reviewer.

8. The system of claim 7 wherein the gift card reviewer is remote from the customer input device.

9. The system of claim 6 wherein the gift card reviewer comprises a human.

10. The system of claim 6 wherein the customer input device is enabled to upload images from a customer via a wired or a wireless connection.

11. The system of claim 6 wherein the customer input device comprises a kiosk.

12. The system of claim 11 wherein the kiosk and printer are remote and on site in relation to each other.

13. A system for reviewing a customized gift card, the system comprising:
a customer input device;
a remote gift card reviewer in communication with the input device; and
a gift card printer constructed and arranged to be controlled by the gift card reviewer.

14. The system of claim 13 wherein the gift card reviewer is on site.

15. The system of claim 13 wherein the gift card reviewer is off site.

16. The system of claim 13 wherein the remote gift card reviewer comprises a human observer, a PC, and a display constructed and arranged to display a gift card design prior to printing the gift card.

17. A method of approving a gift card design comprising:
allowing a customer to customize a gift card design at a first location;
transmitting an image of the gift card design to a gift card reviewer; and
subsequently allowing or disallowing the printing of a gift card including the gift card design.

18. The method of claim 17 wherein the gift card reviewer is remote from the first location.

19. The method of claim 17 wherein the gift card reviewer is off site from the first location.

20. The method of claim 17 wherein the card design is reviewed at the first location.
